(19) United States
(12) Patent Application Publication
(10) Pub. No.: US 2014/0231578 A1
(43) Pub. Date: Aug. 21, 2014

(54) STABILIZED UAV PLATFORM WITH FUSED IR AND VISIBLE IMAGERY

(71) Applicant: BAE Systems Information and Electronic Systems Integration Inc., (US)

(72) Inventor: Barry Lavoie, Lowell, MA (US)

(73) Assignee: BAE Systems Information and Electronic Systems Integration Inc., Nashua, NH (US)

(21) Appl. No.: 13/826,412

(22) Filed: Mar. 14, 2013

Related U.S. Application Data
(60) Provisional application No. 61/661,597, filed on Jun. 19, 2012.

(51) Int. Cl. B64C 39/02; B64C 19/00; B64D 47/08

(52) U.S. Cl. CPC B64C 39/02; B64D 47/08; B64C 19/00
USPC 244/13; 244/4 R; 244/75.1

(57) ABSTRACT

Embodiments of the present invention relate to an unmanned aerial vehicle (UAV) and a method of use. The UAV may comprise a UAV platform designed around a sensor system. The UAV platform may adjust itself in order to stabilize the sensor system. The UAV platform may comprise front UAV wings, back UAV wings, and a payload chamber. The front UAV wings and back UAV wings may adjust themselves by rotating about a line approximately perpendicular to the UAV's flight line. The payload chamber may adjust itself by rotating about the UAV's flight line. The sensor system may be located in an optimal location on the UAV platform, for example, behind the nose as far back as the front UAV wings. The sensor system may comprise an infrared (IR) and a visible camera.

### CROSS REFERENCE TO RELATED CASE

The present invention is related to and claims the benefit of priority of U.S. Provisional Patent application No. 61/661,597, filed on Jun. 19, 2012 and entitled “Stabilized UAV Platform with Fused IR and Visible Imagery.”

### BACKGROUND OF THE INVENTION

1. Field of the Invention

The present invention relates to unmanned aerial vehicles (UAVs) and, more particularly, to a low cost, accurate, and stabilized UAV.

2. Brief Description of Prior Developments

The AeroVironment Raven is an existing UAV. As seen in the accompanying figures, the AeroVironment Raven has a wingspan of approximately 51″ and houses a sensor system in its nose. As minimum size and detection is encouraged in military endeavors, the size of the AeroVironment Raven may be undesirable. Further, the location of the sensor system can make it difficult to stabilize when, for example, the UAV encounters turbulence, or if the operator is looking to acquire image data in a stationary/hover position.

A need, therefore exists, for a smaller, yet high quality, accurate, and stable UAV with the ability to operate in a traditional fixed wing, stationary/hover or gliding mode of operation.

### SUMMARY OF THE INVENTION

An embodiment of the invention described herein is a high quality, accurate, real-time airborne sensor system (e.g. fused infrared and visible imagery) packaged in a man-portable, light-weight, and cost efficient stabilized UAV platform. In an embodiment only one operator is required.

### BRIEF DESCRIPTION OF THE DRAWINGS

Embodiments of the invention, as well as a preferred mode of use, will best be understood by reference to the following detailed description of an illustrative embodiment when read in conjunction with the accompanying drawings, wherein:

FIG. 1 shows a comparison of an isometric view of the existing AeroVironment Raven UAV and a UAV of an embodiment of the present invention.

FIG. 2 shows an alternate comparison view of the existing AeroVironment Raven UAV and a UAV of an embodiment of the present invention.

FIG. 3 shows additional components of an embodiment of a UAV of the present invention, and shows an example of how it may adjust itself.

FIG. 4 shows a payload chamber of an embodiment of a UAV of the present invention, and shows an example of how it may adjust itself.

FIG. 5 shows a UAV in an example stationary/hover position in accordance with an embodiment of the present invention.

### DETAILED DESCRIPTION OF A PREFERRED EMBODIMENT

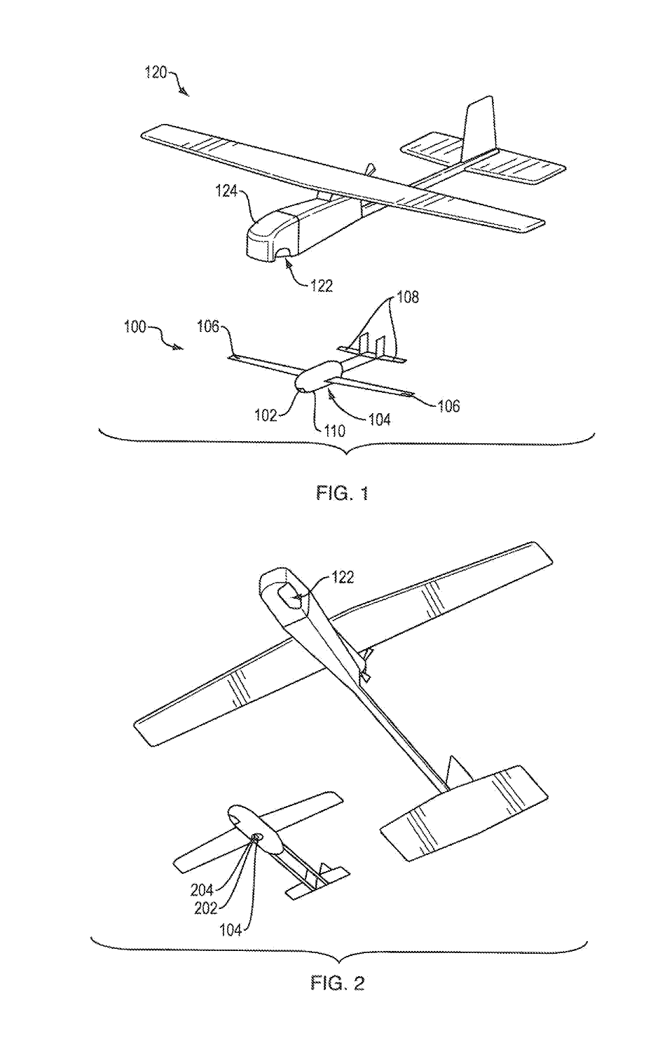

Referring now to the drawings, FIG. 1 show a UAV of the present invention 100 alongside a prior art UAV (the AeroVironment Raven) 120. The UAV of the present invention 100 has a stabilized UAV platform 102 designed around a sensor system 104, in accordance with an embodiment of the present invention. The UAV platform 102 may have front UAV wings 106, back UAV wings 108, and a payload chamber 110. The front UAV wings 106, back UAV wings 108, and payload chamber 110 may all be adjusted, either in combination or alone, to stabilize the sensor system 104 thereby increasing the accuracy and quality of the overall sensor performance. The need to stabilize the sensor system 104 may arise due to turbulence encountered by the UAV 100.

The UAV 100 of the present disclosure is distinguishable from the AeroVironment Raven 120, in which the sensor system 122 is housed in the nose 124 and the wingspan is much, larger. Specifically, the wingspan of the AeroVironment Raven 120 is in excess of 50″, wherein the wingspan of the UAV of the present invention 100 may be less than half of that, for example, approximately 23″. The UAV 100 can be pre-programmed with flight patterns using on-board positioning sensors. The UAV 100 can also be controlled in real-time through handheld controls. In one embodiment, the UAV 100 can be disassembled in minutes when not in use in such a way that it will fit in either a leg-side, arm-side, or a backpack that the operator can easily travel with.

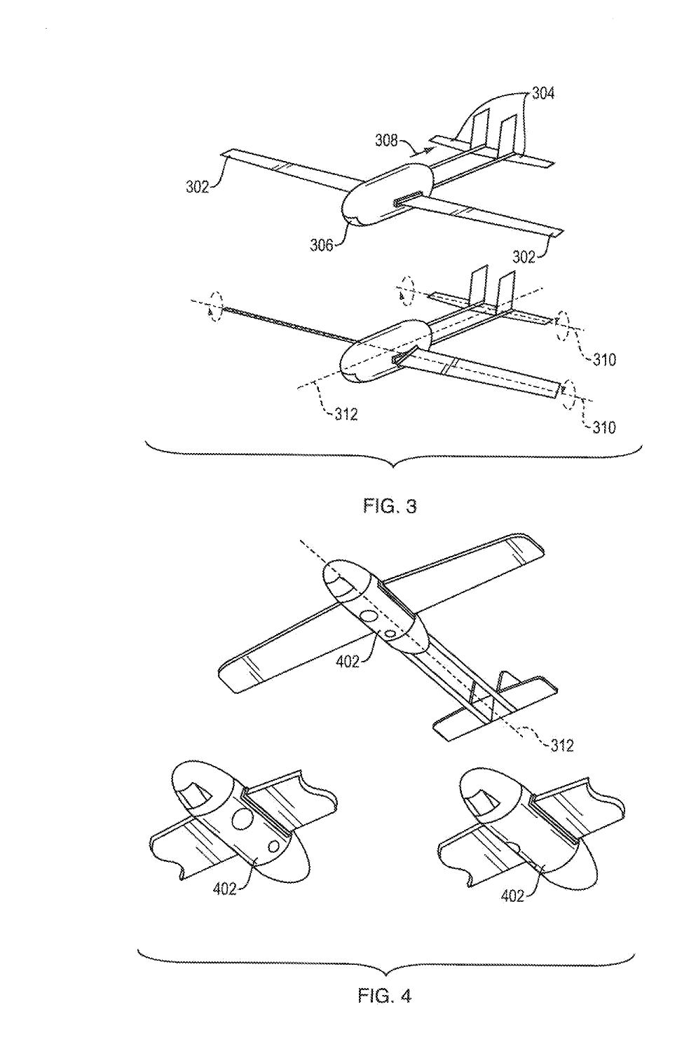

FIG. 2 shows a rotated view of the UAVs shown in FIG. 1. Unlike the sensor system 122 of prior art UAVs, the sensor system 104 of the present invention may not be located in the nose. Rather, it may be located, for example, behind the nose between the front UAV wings as shown. The sensor system 104 may comprise an infrared camera 202 and a visible camera 204.

FIG. 3 shows an isometric view of the UAV in accordance with an embodiment of the present invention. As shown, the front UAV wings may contain operational accelerometers 302 and the back UAV wings may contain operational accelerometers 304. Additionally, the UAV may contain air intakes 306 and air exhausts 308. As shown, to adjust themselves, the front UAV wings and back UAV wings may rotate about lines 310 that are approximately perpendicular to the UAV's flight line 312.

FIG. 4 shows the payload chamber 402 used in an embodiment of the present invention, and gives multiple views of the UAV's sensor system. As one can see, the payload chamber 402 adjusts itself by rotating about the UAVs flight line 312. The sensor system may rotate with the payload chamber 402, thereby enabling the operator to have a wider field of view.

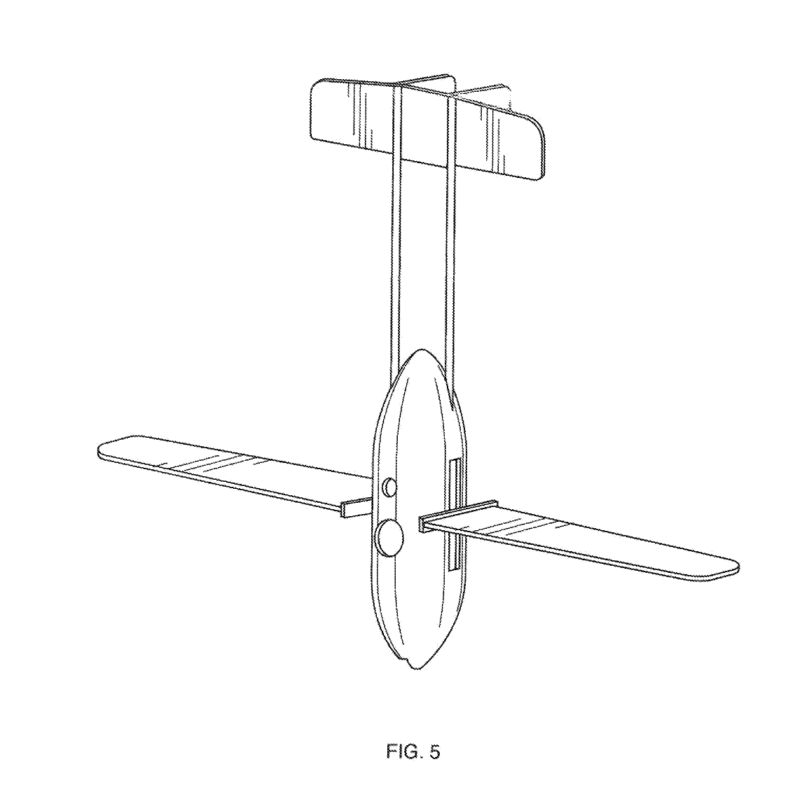

FIG. 5 shows an example UAV in a stationary/hover position in accordance with an embodiment of the present invention. One object of the invention may be to stabilize the sensor system in, for example, the following modes of operation: traditional fixed wing, stationary/hover and glide.

While the present invention has been described in connection with the preferred embodiments of the various figures, it is to be understood that other similar embodiments may be used or modifications and additions may be made to the described embodiment for performing the same function of the present invention without deviating there from. Therefore, the present invention should not be limited to any single embodiment, but rather construed in breadth and scope in accordance with the recitation of the appended claims.

What is claimed is:

1. An unmanned aerial vehicle (UAV) comprising:
a sensor system; and
a UAV platform designed around said sensor system, wherein said UAV platform adjusts itself to stabilize said sensor system.

2. The UAV of claim 1 wherein said sensor system has an infrared (IR) camera and a visible camera.

3. The UAV of claim 1 wherein said UAV platform comprises:
front UAV wings;
back UAV wings; and
a payload chamber, wherein said sensor system is attached to said payload chamber such that it rotates with said payload chamber.

4. The UAV of claim 3 wherein said front UAV wings, said back UAV wings, and said payload chamber adjust themselves independent of one another.

5. The UAV of claim 3 wherein said front UAV wings and said back UAV wings adjust themselves by rotating about a line approximately perpendicular to a flight line of said UAV.

6. The UAV of claim 3 wherein said payload chamber adjusts itself by rotating about a flight line of said UAV.

7. The UAV of claim 3 wherein said sensor system is located approximately as fu back from a nose of said UAV as said front UAV wings.

8. The UAV of claim 3 wherein said UAV platform has a wingspan of approximately 23 inches.

9. The UAV of claim 3 wherein said UAV platform is pre-programmed with flight patterns using on-hoard positioning sensors.

10. The UAV of claim 3 wherein said UAV platform is controlled with handheld controls.

11. The UAV of claim 3 further comprising operational accelerometers attached to said front UAV wings and said back UAV wings.

12. The UAV of claim 3 further comprising:
at least one air intake; and
at least one air exhaust.

13. A method of using a UAV comprising the steps of
acquiring a UAV having a sensor system and a UAV platform designed around said sensor system; and
adjusting said UAV platform to stabilize said sensor system.

14. The method of claim 13 wherein said UAV platform comprises:
front UAV wings;
back UAV wings; and
a payload chamber, wherein said sensor system is attached to said payload chamber such that it rotates with said payload chamber.

15. The method of claim 14 wherein the adjusting step comprises rotating said front UAV wings about a line approximately perpendicular to a flight line of said UAV.

16. The method of claim 14 wherein the adjusting step comprises rotating said hack UAV wings about a line approximately perpendicular to a flight line of said UAV.

17. The method of claim 14 wherein the adjusting step comprises rotating said payload chamber about a flight line of said UAV.

18. The method of claim 14 wherein the adjusting step comprises:
rotating said front UAV wings about a line approximately perpendicular to a flight line of said UAV;
rotating said back UAV wings about a line approximately perpendicular to said flight line; and
rotating said payload chamber about said flight line.

19. An unmanned aerial vehicle (UAV) comprising:
a sensor system;
front UAV wings;
back UAV wings; and
a payload chamber; wherein said sensor system is attached to said payload chamber such that it rotates with said payload chamber, wherein said front UAV wings, said back UAV wings, and said payload chamber adjust themselves independent of one another to stabilize said sensor system.

20. The UAV of claim 19 wherein said front UAV wings and said back UAV wings adjust themselves by rotating about a line approximately perpendicular to a flight line of said UAV, and said payload chamber adjusts itself by rotating about said flight line.
